(19) United States
(12) Patent Application Publication
(10) Pub. No.: US 2005/0269435 A1
(43) Pub. Date: Dec. 8, 2005

(54) Bushing for a rock crusher

(75) Inventors: Ulhas S. Sawant, Hartland, WI (US); James A. Sheridan, Greendale, WI (US)

Correspondence Address: John M. Manion;RYAN KROMHOLZ & MANION, S.C., Post Office Box 26618, Milwaukee, WI, 53226-0618, US

(73) Assignee: Innotech Solutions, LLC

(21) Appl. No.: 10/861,953

(22) Filed: Jun. 4, 2004

(51) Int. Cl. B02C 2/00

(52) U.S. Cl. 241/207

(57) ABSTRACT

A tapered bushing for use in connection with a shaft for a rock crusher. The bushing tapers inwardly from top to bottom and the thickness of the bushing also tapers evenly from a first maximum predetermined thickness to a second minimum predetermined thickness.

### BACKGROUND OF THE INVENTION

The present invention relates to rock crushers and to improved bushings used in connection with the rock crushers.

Crushing stones and rocks requires rugged and sturdy equipment that can stand up to the harsh environment and heavy loads of rock crushing.

In conical rock crushers, a shaft and head assembly gyrates to crush rocks. The gyrating motion is imparted to the shaft through a bushing. The shaft bears on one side of the bushing during the rock crushing load. However the shaft tends to rub and burn the bushing on the opposite side, especially when the rock crusher is running without a load, such as before starting or after stopping the rock crushing process. Prior art designs provide uneven and point contact between the bushing surface and the shaft, which contributes to the burning of the bushing. Thus, an improved bushing is desired.

### SUMMARY OF THE INVENTION

The present invention provides an improved bushing for use in a rock crusher. Within the rock crusher sits a crusher head and a shaft assembly. The assembly rotates or gyrates, which allows a mantle located on the exterior of the crusher head to come in contact with the rock crusher bowl for crushing rocks. As the shaft gyrates, especially without rocks within the crusher bowl, the shaft comes in contact with the bushing, which acts as an abutting surface for the maximum outer movement of the shaft. The bushing is tapered downwardly, which allows for evenly dispersed contact along the length of the shaft as it gyrates. Furthermore, the thickness of the bushing is asymmetrical, with the thickness evenly varying from a predetermined maximum thickness to a predetermined minimum thickness. The asymmetrical thickness further provides for an even abutting surface for the shaft to contact. The result is a shaft load that is dispersed over a wide area of the bushing, which minimizes burning of the bushing. In addition, the reduced clearance between the shaft and the bushing creates better hydrodynamic bearing action, resulting in enhanced load capabilities for the bushing. Overall, the combination of the factors improves the reliability of the crusher and the crushing process.

### BRIEF DESCRIPTION OF THE DRAWINGS

FIG. 1 depicts a side elevational view, partially in section, of a rock crusher currently used in the art.

FIG. 2 depicts an enlarged view of a prior art shaft and bushing.

FIG. 3 depicts a view, similar to that of FIG. 2, of a shaft and bushing in accordance with the present invention.

FIG. 4 depicts an overhead view of the shaft and improved bushing in accordance with the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

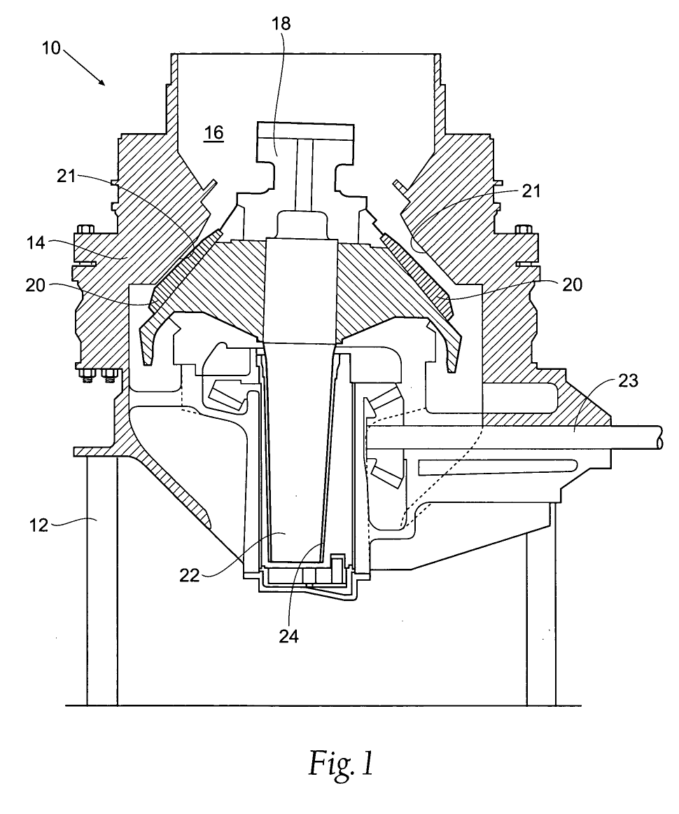

FIG. 1 depicts a side elevational view, partially in section, of a rock crusher 10. The crusher 10 is shown without any rocks within the assembly, that is, the rock crusher is being shown operating without a crushing load. The crusher 10 comprises a supporting base 12 that supports a stationary frame 14. The frame 14 provides a generally concave crushing bowl or container 16. Within the crushing bowl 16 resides a crusher head 18. Mounted on the outside of the crusher head 18 is a mantle 20, which interacts with the inner surface 21 of the crushing bowl 16 to crush the rocks when they enter the bowl 16. The crusher head 18 is assembled to a shaft 22, which gyrates about the main axis of the crusher to allow the crusher head 18 to crush rocks against the sides of the bowl 16. The shaft 22 is connected to a drive shaft or other power means 23 that provides power for the shaft 22 and the crusher head 18 to gyrate or rotate. A bushing 24, located around the shaft 22, provides means that will carry the radial load of the crusher 10 during crushing and non-crushing time intervals. The bushing 24 is the focus of the present invention.

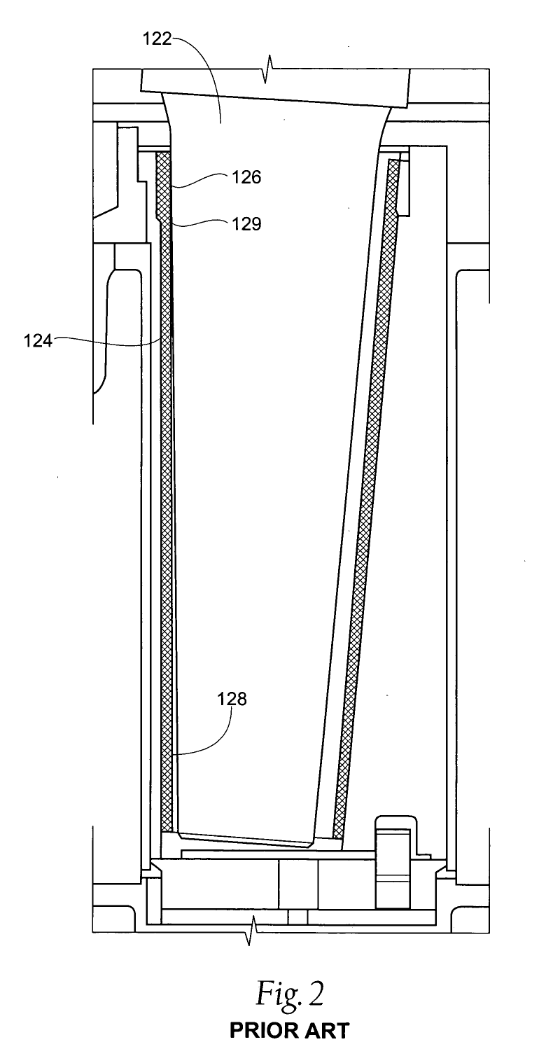

FIG. 2 shows a shaft 122 and a bushing 124 according to the prior art. It will be understood that when referring to the shaft 122, we are referring to the area of the shaft 122 that is positioned within the bushing 124, and not the entire length of the shaft 122, which normally will extend further upward into the center of the crusher head 18. The bushing 124 has a top end 126 and a bottom end 128 and is of a generally cylindrical shape. The shaft 122, as shown, would be gyrating without a load of rocks in the container 16 (see FIG. 1). When this happens, the outer limit of the movement of the shaft 122 is defined by the bushing 124. The shaft 122 contacts the top end 126 of the bushing 124 when rotating but does not contact the bottom end 128 of the bushing 124, as is evident in the drawing. As this occurs, the force and pressure exerted on the bushing 124 is concentrated at a specific pinch point 129 at the top end 126 of the bushing 124. The bottom end 128 of the bushing 124 does not make contact with the shaft 122. The concentration of force at the pinch point 129 of the bushing 124 leads to burning of the bushing 124, which leads to the failure of the bushing 124 and other adverse effects on the crusher 10.

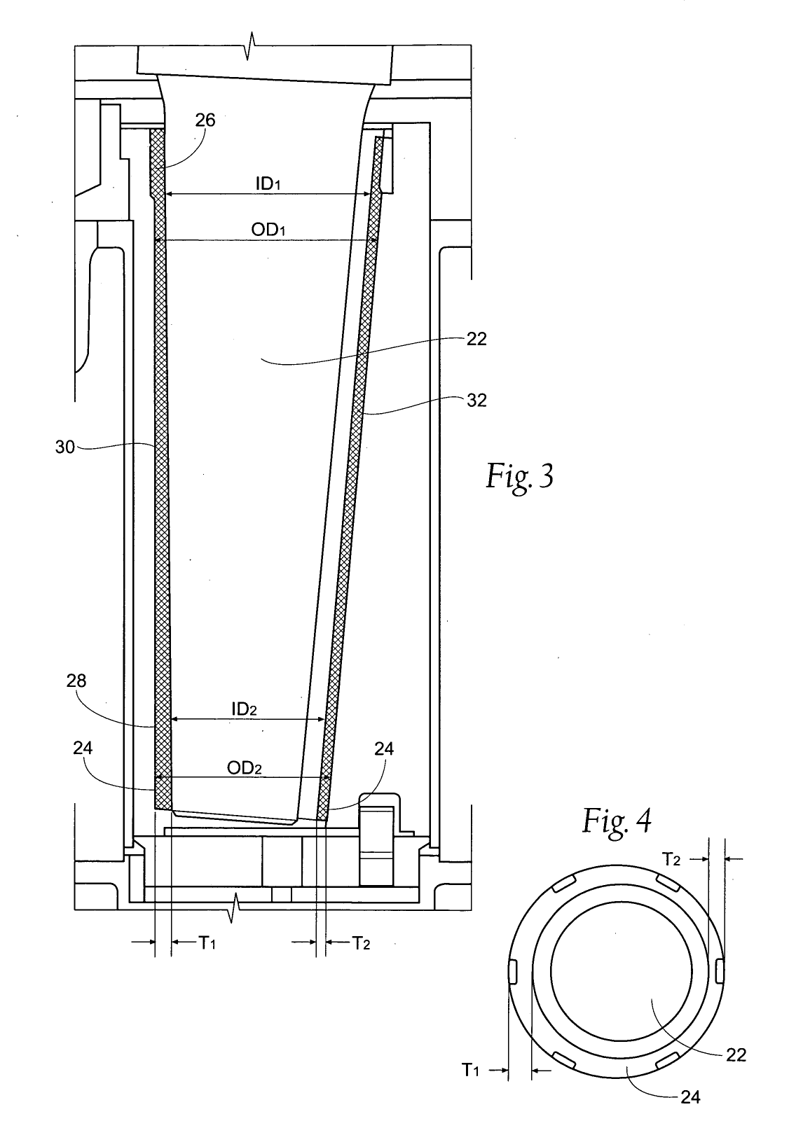

FIG. 3 shows a side elevational view of the shaft 22 and the bushing 24 in accordance with the present invention. As stated with respect to the prior art, it is to be understood that the shaft refers to the area of the shaft that contacts the bushing 24, and not the entire shaft 22. As shown with the prior art in FIG. 2, the shaft 22 is also rotating without a load of rocks in the container 16, as shown in FIG. 1. As disclosed in FIG. 3, the bushing 24 has a top end 26 and a bottom end 28. The bushing 24 evenly tapers inwardly from the top end 26 to the bottom end 28, which results in the top end 26 having a first inner diameter ID₁ larger than that of a second inner diameter ID₂, located at the bottom end of the bushing 24. The arrangement of the bushing 24 allows the shaft 22 to evenly be in contact along the entire length of the bushing 24 and removes the pinch point 129 discussed with respect to the prior art assembly shown in FIG. 2. The bushing 24 provides an abutment for the shaft 22 that is coextensive along the length of the shaft 22. Thus, contact between the shaft 22 and the bushing 24 is linearly displaced along the entire length of the shaft 22 as opposed to a single point, with the result being substantially less burning of the bushing 24 and a longer life for the bushing 24. Burning of the bushing 24 is virtually eliminated according to the present invention. A longer bushing life equates into less downtime for a rock crusher previously required to replace worn bushings, which leads to an increase in productivity.

Still referring to FIG. 3, the bushing 24 has a first outer diameter OD₁ located at the top end 26 of the bushing 24 and a second outer diameter OD₂ located at the bottom end 28 of the bushing, with the second outer diameter OD₂ being preferably less than that of the first outer diameter OD₁. The outer diameters are spaced apart from the inner diameters for illustrative purposes and to distinguish and clarify what dimension is referred to for each diameter; the respective inner and outer diameters should be considered as intersecting the bushing 24 at the same latitude. The outer diameters and the inner diameters are eccentric of one another, or are not centered on the same axes. More specifically, the first inner diameter ID₁ is eccentric of the first outer diameter OD₁, and the second inner diameter ID₂ is eccentric of the second outer diameter OD₂. However, the outer diameters OD₁ and OD₂ may be substantially coextensive along the same axes.

Referring further to FIG. 3, the bushing 24 is shown having a first side 30 and a second side 32. The bushing 24 normally encircles the shaft 22, but is shown having the first side 30 and the second side 32 for illustrative purposes. Because of the eccentric diameters discussed above, the first side 30 has a first thickness T₁ and the second side 32 has a thickness T₂. The thickness T₁ is thicker than the thickness T₂. The overall thickness of the bushing 24 tapers evenly from the thickness T₁ to the thickness T₂. The tapered thickness of the bushing also contributes to the solid contact made between the shaft 22 and the bushing 24, thereby further reducing potential burning of the bushing 24.

FIG. 4 depicts an overhead view of the shaft 22 and the bushing 24. As described with respect to FIG. 3, the overall thickness of the bushing 24 tapers evenly from the greatest thickness T₁ to the narrowest thickness T₂. The thicknesses T₁ and T₂ do not necessarily need to be located on the right and left sides of the shaft 22, respectively. Since the bushing 24 is preferably circular throughout its length, it should be understood that actual orientation of the thickness T₁ and T₂ will be determined as to what angle or perspective a person is looking at the shaft 22 and the bushing 24. The maximum thickness of the bushing would be considered T₁ and the minimum thickness T₂ would be considered, regardless of what direction or angle the bushing 24 was viewed.

The inward tapering of the bushing 24 and the tapering of the thickness do not have to be substantial to result in the desired effect for the assembly 10. For instance, in many industrial-sized rock crusher assemblies, the shaft 22 may be about 45 inches in length. This would be the length below the rock crusher head, and not include the length of the shaft that may extend inwardly of the crusher head. The first inner diameter ID₁ may be approximately about 13⅞ inches and the second inner diameter ID₂ may be approximately about 10¼ inches. The change in the bushing diameter is around 3 to 3½ inches, or approximately 1 inch taper in thickness for every 12 to 15 inches of the length of the shaft. Similarly, the difference between the thickness T₁ and T₂ of a bushing, for a shaft of about 45 inches in length, is approximately 130 mils, or approximately ⅛ of an inch. The slight adjustments are enough to provide for a more efficient bushing. It should also be understood that the above values could be adjusted depending on specific needs or arrangements for a rock crusher. Provided that the varying of the bushing dimensions conveys an even, abutting surface along the entire length of the shaft, the values would fall within the scope of the invention.

The bushing 24 has been discussed as being evenly tapered. It may be possible that the outside of the bushing does not evenly taper, and the bushing would still fall within the scope of the invention. Also, either the top of the bushing or bottom of the bushing, where the bushing may not come in contact with the shaft, may not necessarily be evenly tapered either. Provided that the surface of the bushing that comes into contact with the surface of the shaft is evenly tapered so that individual pinch points between the shaft and the bushing are removed, the bushing would fall within the scope of the invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A bushing for use in a conical rock crusher, said rock crusher including a generally concave crushing bowl and a crusher head including a mantle mounted on the outside of the crusher head, said mantle interacting with said crushing bowl for crushing rocks, said crusher head being assembled onto a shaft, said bushing providing an abutting supporting surface coextensive with the length of the exterior surface of said shaft, said shaft having a central longitudinal axis extending the length of said shaft, said bushing comprising:
an upper end including a first diameter being laterally spaced apart from an upper end of said shaft;
a lower end including a second diameter being laterally spaced apart from a lower end of said shaft, said second inner diameter being less than that of said first inner diameter;
said bushing being evenly tapered from said upper end to said lower end;
said upper end having a first outer diameter;
said lower end having a second outer diameter being less than that of said first outer diameter, said first and second outer diameters being eccentric of said first and second inner diameters, respectively.

2. The bushing according to claim 1, wherein said longitudinal axes of said first and second outer diameters are coextensive.

3. A bushing for a gyrating shaft, said bushing comprising:
a generally cylindrical body, said body having a thickness evenly varying in size from a predetermined maximum thickness to a predetermined minimum thickness.

4. The bushing according to claim 3 wherein said body further comprises:
an upper end, said upper end having a first inner diameter; and
a lower end having a second inner diameter, said second inner diameter being less than said first inner diameter, said body being evenly tapered from said upper end to said lower end.

5. The bushing according to claim 4 wherein said bushing and said shaft are in linear contact along the length of said shaft when said shaft is gyrating.
